(19) United States
(12) Patent Application Publication
(10) Pub. No.: US 2001/0044867 A1
(43) Pub. Date: Nov. 22, 2001

(54) System and process based on hierarchical PCI bus architecture

(75) Inventor: Max-Yuan-Chang Tsou, Hsin Chu City (TW)

Correspondence Address: KLARQUIST SPARKMAN CAMPBELL, LEIGH & WHINSTON, LLP, One World Trade Center, Suite 1600, 121 S.W. Salmon Street, Portland, OR, 97204-2988, US

(73) Assignee: MENTOR DATA SYSTEM, INC.

(21) Appl. No.: 09/894,025

(22) Filed: Jun. 27, 2001

(30) Foreign Application Priority Data
Sep. 11, 1998 (TW) 87115152

(51) Int. Cl. G06F 13/38; G06F 13/40

(52) U.S. Cl. 710/126

(57) ABSTRACT

The disclosure relates to a hierarchical PCI (peripheral component interconnect) bus architecture, particularly to a hierarchical PCI bus architecture applied to the VOD (video on demand) system in an Ethernet Network. The architecture includes a plurality of PCI banks, at least a SCSI bank, and a plurality of PCI bridges. Each PCI bank connects a logic processor via at least one PCI bridge, also connects the SCSI bank via at least one PCI bridge. The logic processor receives video demand signals from users, and sends a service command block to the SCSI bank, for the SCSI bank to retrieve, according to the service command block and from a data storage bank, the video data demanded by the users, and sends the demanded video data to a memory of a PCI bank, so that the demanded video data is transmitted by the PCI bank from the memory to users via a network.

### FIELD OF THE INVENTION

The present invention relates to a hierarchical architecture of PCI (peripheral component interconnect) bus, particularly to a hierarchical architecture of PCI bus applied to the VOD (video on demand) system in an Ethernet Network.

### BACKGROUND OF THE INVENTION

With the progress of technology and the promotion of living quality of human beings, VOD service is gradually becoming popular and receiving attention worldwide. However, it is critically important that a VOD system is capable of transmitting, in response to request signals, the same or different real-time multi media data to a large number of remote users. The performance of such a VOD system particularly deserves attention in case the remote users hope to interactively access the real-time multi media data.

A VOD system is usually required to work with large data storage capacity, high data transfer rate, and large data output bandwidth. This is why most of video servers are associated with solutions focusing on using disk arrays, high-end powerful computers, high-bandwidth network interfaces, and fast switches to maximize their capability.

Most of video servers connect data storage devices via SCSI (small computer system interface) bus. A more ideal video server needs a plurality of disk arrays working in parallel so that fast retrieval of current top hits, hot movies, or other regularly played program contents can be achieved. There may also be secondary content storage devices such as tape libraries containing a huge amount of data that is not often accessed. It is better for a video server to have many available SCSI ports and each of the SCSI ports is regarded as an individual SCSI bus to interface with multiple units of storage devices which may run at very different speeds. However, most video servers include few SCSI ports due to the limitation inherent in hardware platform.

PCI (peripheral component interconnect) bus is an open standard configuration based on which high performance system I/O buses are constituted. As an open standard configuration, PCI bus has been widely adopted in PC industry. It must be noted that each of most computer systems includes only one single PCI bus supporting four PCI slots, and uses a PCI-PCI bridge to extend the single PCI bus to try overcoming electrical loading limits. The bandwidth and overall system capacity provided by such a conventional PCI bus structure are usually subject to bus traffic congestion.

### SUMMARY OF THE INVENTION

An object of the present invention is to provide a hierarchical PCI bus architecture for significantly raising the number of network communication ports and SCSI ports of a video server engine, thereby the storage capacity and output network bandwidth can be greatly enhanced.

Another object of the present invention is to provide a hierarchical PCI bus architecture for transmitting a large amount of multi media data from a PCI bus memory unit (a memory unit connected with a PCI bus) via the network communication ports of the same PCI bus, without interfering with the data stream of the other PCI buses or the other buses, thereby multi media data can be smoothly transmitted to users.

A feature of the hierarchical PCI bus architecture provided by the present invention is that the memory and each network communication controller in a PCI bank connect a PCI bank bus respectively via a PCI bridge, thereby the interference between the data stream of the PCI bank bus and the input/output of any network communication controller or the memory can be avoided; similarly the memory and each SCSI controller in a SCSI bank connect a SCSI bank bus respectively via a PCI bridge, thereby the interference between the data stream or program command stream of the SCSI bank bus and the input/output of any SCSI controller/memory can be avoided.

Another feature of the hierarchical PCI bus architecture provided by the present invention is that each of plural PCI banks and the SCSI bank connect a backbone bus respectively via a PCI bridge, wherein the backbone bus connects a logic processor (such as a CPU or a combination of memory and logic circuits) via a PCI bridge, thereby the interference between the data stream of the backbone bus and the input/output of the logic processor can be avoided, also the interference between the backbone bus and each PCI bank/SCSI bank bus can be avoided.

A further feature of the hierarchical PCI bus architecture provided by the present invention is that the SCSI bank transfers data, with significantly high speed, from a data storage bank to the memory of a PCI bank via the backbone bus, thereby the network communication controller of the PCI bank transmits, adapting to the specification of a network, the data from the memory of the same PCI bank to users via the network, resulting in significant smoothness of data flow in the backbone bus.

It can be understood now that the hierarchical PCI bus architecture provided by the present invention offers an effective solution to bus congestion often faced by systems such as a video server, benefiting not only Ethernet network communication, but also any other communication system. In fact, it can further be used to assure smooth data flow in any bus of a system such as a video server or any data broadcasting system, particularly an interactive video data broadcasting system. Noticeably it deserves special attention that the capability of such a hierarchical PCI bus architecture for realizing a significant increase in the number of communication ports of a data broadcasting system is exactly what a conventional PCI architecture cannot achieve.

### BRIEF DESCRIPTION OF DRAWINGS

FIG. 1 illustrates an example of an outline of a VOD system.

FIG. 2 illustrates a connection configuration of a hierarchical PCI bus architecture embodied according to the present invention for a video server.

FIG. 3 illustrates an example of internal connection configuration of a PCI bank embodied according to the present invention to be part of the hierarchical PCI bus architecture shown in FIG. 2.

FIG. 4 illustrates an example of internal connection configuration of a SCSI bank embodied according to the present invention to be part of the hierarchical PCI bus architecture shown in FIG. 2.

FIG. 5 illustrates an embodiment of data retrieval and transmittal flow in the hierarchical PCI bus architecture provided by the present invention.

### REFERENCE SIGNS

12 logic processor

14 PCI (peripheral component interconnect) bridge

16 PCI (peripheral component interconnect) bank

18 SCSI (small computer system interface) bank

20 video server engine

22 logic processor input/output port bus

24 backbone bus

30 user

40 server management unit

50 Ethernet network

162 network card

164 memory card

166 PCI bank bus

182 SCSI card

184 memory card

186 data storage bank (or data base)

188 SCSI bank bus

1622 network communication controller

1624 network interface port

1642 memory controller

1644 memory

1822 SCSI controller

1824 SCSI port

1842 memory controller

1844 memory

### DETAILED DESCRIPTION OF THE INVENTION

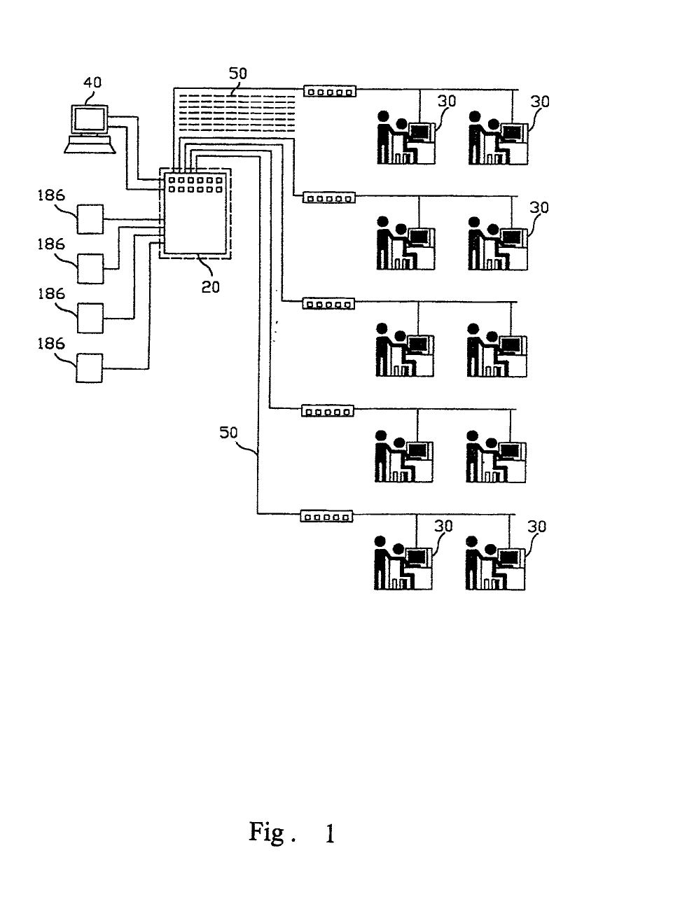

In FIG. 1, a video server engine 20 is used to broadcast multi media data from data storage bank 186 to a plurality of users 30 via an Ethernet network 50.

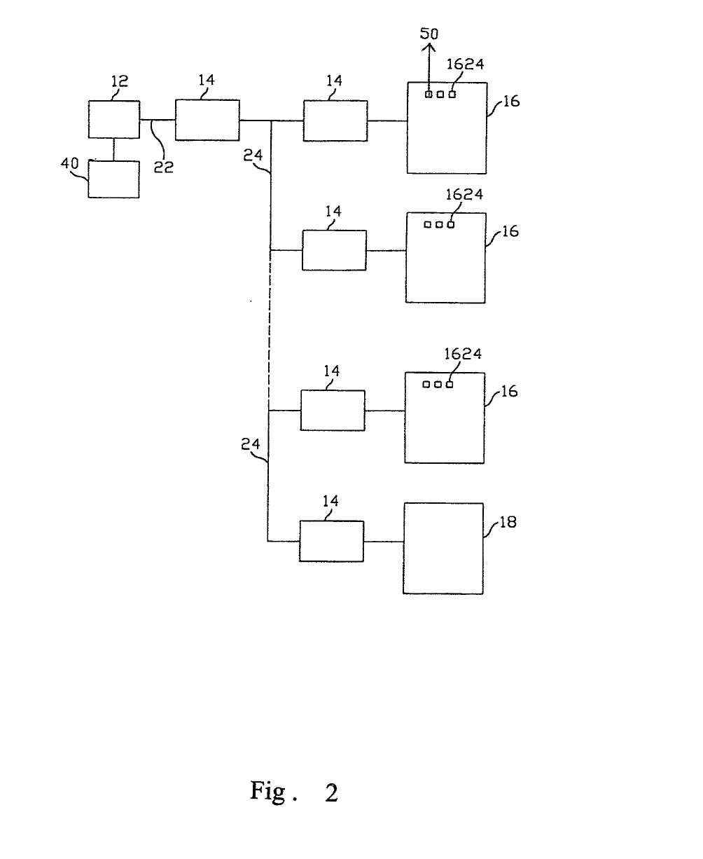

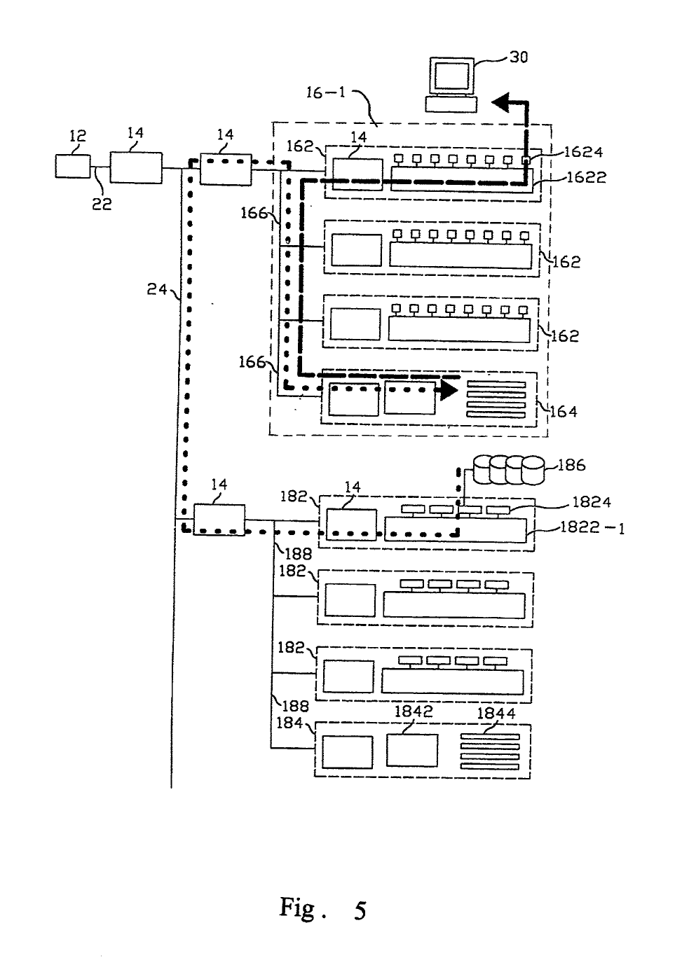

An embodiment of a hierarchical PCI system (such as a video server engine) provided by the present invention for broadcasting data from at least a data storage bank to users via a network may be illustrated by referring to FIGS. 2, 3 and 4. The embodiment of such a system comprises: A logic processor 12; a plurality of PCI banks 16 each including at least a network interface port 1624; at least a SCSI bank 18; a PCI bridge bank including a plurality of PCI bridges 14. Each PCI bank 16 connects logic processor 12 respectively via at least a PCI bridge 14, and also connects SCSI bank 18 via at least a PCI bridge 14 (although the connections among these devices are via a backbone bus 24 according to these figures, the backbone bus 24 is not indispensable, and these devices may be connected to each other respectively via a PCI bridge 14). Logic processor 12 is used to receive video demand signals sent from users 30, and to send, upon verifying the validity of the video demand signals, a service command block to SCSI bank 18, thereby SCSI bank 18 retrieves, according to the service command block and from the data storage bank, the video data demanded by users 30 and sends the demanded video data to a corresponding PCI bank 16-1 (FIG. 5) to be transmitted to the users via the network interface port 1624 of the corresponding PCI bank 16-1 and the network, wherein the corresponding PCI bank 16-1 is selected from among the plurality of PCI banks 16 (FIG. 2) according to the service command block, and the validity of the video demand signals is verified by checking attributes of a request command packet of the video demand signals, such as the request command packet's command sequence number, transfer length, target data, storage location, start/end byte, and transfer data length.

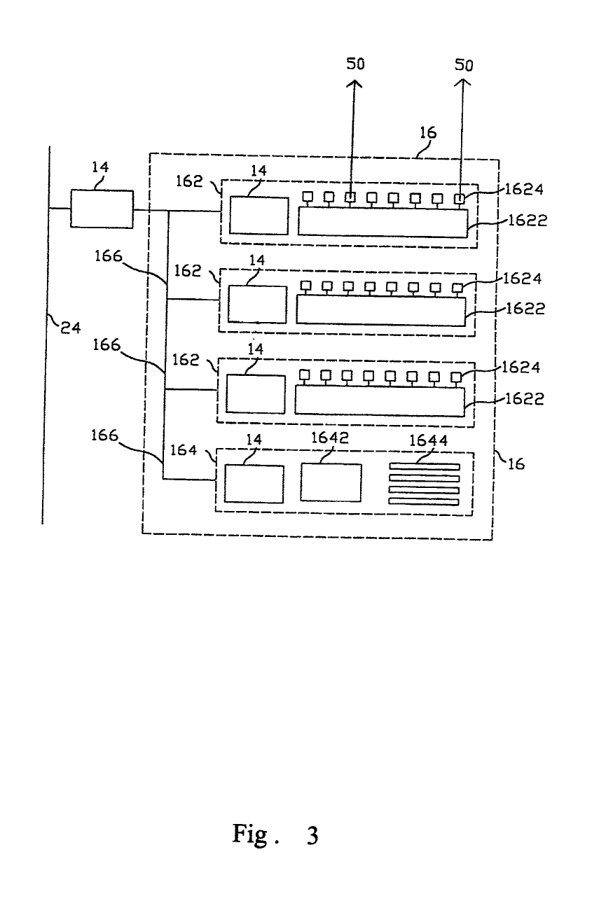

In the hierarchical PCI system provided by the present invention and shown in FIGS. 2, 3, and 4, each PCI bank 16 may further includes a memory card 164 and at least a network communication controller 1622 connecting at least a network interface port 1624, the memory card 164 for storing the video data received from the SCSI bank and storing an operating program, thereby the network communication controller 1622 transmits the video data from the memory card 164 to the user via the network interface port 1624 connecting therewith and the network. The memory card 164 may include a memory 1644, a memory controller 1642, and a PCI bridge 14, wherein memory 1644 is connected to a PCI bank bus 166 (FIGS. 3 and 5) via memory controller 1642 and the PCI bridge 14. The PCI bank bus 166 connects each network communication controller 1622 and backbone bus 24 respectively via a PCI bridge 14.

In the hierarchical PCI system provided by the present invention and shown in FIGS. 2, 3, and 4, each PCI bank 16 may further include a PCI bank bus, wherein the memory card 164 and each network communication controller 1622 connect the PCI bank bus respectively via one of the PCI bridges.

The hierarchical PCI system provided by the present invention and shown in FIGS. 2, 3, and 4 may further comprise a backbone bus 24, wherein each PCI bank 16 and each SCSI bank 18 connect the backbone bus 24 respectively via one of the PCI bridges, and backbone bus 24 connects the logic processor 12 also via one of the PCI bridges 14.

In the hierarchical PCI system provided by the present invention and shown in FIGS. 2, 3, and 4, each network communication controller 1622 drives at least a network interface port 1624, and the SCSI bank 18 includes at least a SCSI controller such as 1822 (FIG. 2), or 1822-1 (FIG. 5), and a data storage bank 186 connecting a SCSI controller 1822 or 1822-1 via a SCSI port 1824, thereby the SCSI controller 1822 or 1822-1 retrieves from the data storage bank 186 the video data demanded by the user, and sends the demanded video data to the memory card 164 of the corresponding PCI bank 16-1 in which the network communication controller 1622 transmits the demanded video data from the memory card 164 to the user via a network interface port 1624 thereof and the network. The speed for transmitting the demanded video data is determined by the network communication controller before the transmission according to an attribute of the content of the demanded video data.

In the hierarchical PCI system provided by the present invention and shown in FIGS. 2, 3, and 4, each PCI bank includes a plurality of slots (not shown in the figures) for plugging at least one network communication controller 1622 therein, and the SCSI bank 18 also includes a plurality of slots (not shown in the figures) for plugging at least one the SCSI controller therein.

In the hierarchical PCI system provided by the present invention and shown in FIGS. 2, 3, and 4, the logic processor 12 includes a firmware and at least an interrupt service routine block, the firmware for driving network interface port 1624 and executing the interrupt service routine block, the logic processor 12 also includes a memory (not shown in the figures) for storing user information and content location information of the video data. The user information includes user identification, user on-line record, and user passwords, The content location information of the video data contains bank number, card number (in case there are more than one card), port number, device number, and logical block address, based on which the content of the video data demanded by the users can be accessed from a data storage bank. The logic processor 12 issues the SCSI service command block according to the user information, the content location information of the video data, and the video demand signals received from the user; and then sends the SCSI service command block to the SCSI bank 18.

In the hierarchical PCI system provided by the present invention and shown in FIGS. 2, 3, and 4, the interrupt service routine block includes an interrupt service routine for controlling data transfer bit rate, another interrupt service routine for processing the SCSI service command block, and the other three interrupt service routines for managing failure of the SCSI bank. The SCSI service command block includes content location of the video data demanded by the user, content bit rate, data start address, location of the network interface port via which the video data is to be transmitted to the user, and actual data length to play.

Memory 1844 of the SCSI bank 18 stores low-level scrip programs for directing SCSI controller 1822, and SCSI service command block for driving SCSI controller 1822, as well as the data which, if residing in a data storage bank 186, would lower system performance or operation efficiency. Memory 1844 of the SCSI bank 18 also serves a buffer for swapping auxiliary data between different devices of the SCSI bank 18. Memory controller 1844 is connected to SCSI bank bus 188 via a PCI bridge 14 and a memory controller 1842.

SCSI bank 18 includes a SCSI bank bus 188 for connecting backbone bus 24 via a PCI bridge 14, and connecting each SCSI controller 1822 respectively via a PCI bridge 14.

The hierarchical PCI system provided by the present invention and shown in FIGS. 2, 3, and 4 may further comprise a server management unit 40 for storing information about the video data and for providing the logic processor 12 with the stored information about the video data, thereby the logic processor 12 issues the SCSI service command block according to the stored information about the video data, and the video demand signals received from the user.

Referring to FIGS. 2, 3, 4, and 5 now to illustrate a process working with a hierarchical PCI system for broadcasting video data from at least a data storage bank to users via a network. Such a process comprises the steps of:

(1) receiving a video demand signal from the user 30 via a network interface port 1624 (FIGS. 2 and 3) of the hierarchical PCI system;

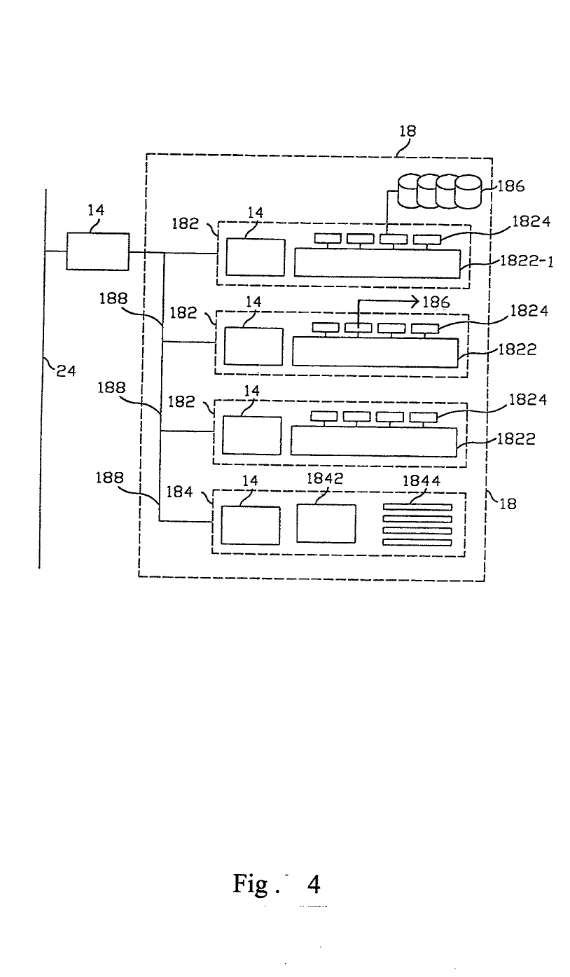

(2) locating a corresponding SCSI controller 1822-1 (FIGS. 4 and 5) according to the video demand signal, the corresponding SCSI controller 1822-1 is one of SCSI controllers 1822 (FIG. 4) of the hierarchical PCI system, and corresponds to the video demand signal;

(3) providing a SCSI service command block to drive the corresponding SCSI controller 1822-1 for retrieving from a data storage bank 186 connected therewith the video data demanded by the user, and sending the retrieved video data demanded by the user to a memory card 164 of a corresponding PCI bank 16-1 (FIG. 5) of the PCI system, wherein the corresponding PCI bank 16-1 is selected from among the PCI banks 16 shown in FIG. 2 according to the service command block; and

(4) transmitting the retrieved video data demanded by the user from the memory card 164 of the corresponding PCI bank 16-1 (FIG. 5) to the user via a network interface port 1624 of the corresponding PCI bank 16-1 and the network.

The step (2) above may include a step of sending the video demand signal to a server management unit 40 (FIG. 2) of the hierarchical PCI system for the server management unit 40 to find the location of the corresponding SCSI controller 1822-1. The server management unit 40 may further find video-data-related information including content bit rate and data start address of the video data, location of the network interface port 1624 via which the video data is to be transmitted to the user, and the actual data length of the video data to play, and sends the video-data-related information to the corresponding SCSI controller 1822-1, thereby the corresponding SCSI controller 1822-1 retrieves, according to the video-data-related information and from a data storage bank 186, the video data demanded by the user, and sends the retrieved video data demanded by the user to the memory card 164 (FIG. 5) of the corresponding PCI bank 16-1 (refer to FIG. 5), whereby a network communication controller 1622 (FIG. 3 and 5) of the corresponding PCI bank 16-1 transmits, according to the video-data-related information, the video data demanded by the user from the memory 164 to the user via a network interface port 1624 of the corresponding PCI bank 16-1 and the network.

The above process may further comprise, before step (3), a step of executing a first interrupt service routine to provide a first routine output, thereby the SCSI service command block is provided to the corresponding SCSI controller 1822-1 in response to the first routine output.

The above process may also further comprise, before step (5), a step of executing a second interrupt service routine to provide a second routine output, thereby the video data demanded by the user is transmitted, with a data length and content bit rate corresponding to the second routine output, to the user via a network interface port 1622 (FIG. 5) of the PCI bank 16-1.

Obviously the hierarchical PCI system provided by the present invention may not need to include a logic processor, it may just work with an external logic processor.

While the invention has been described in terms of what are presently considered to be the most practical and preferred embodiments, it shall be understood that the invention is not limited to the disclosed embodiment. On the contrary, it is intended to cover various modifications and similar arrangements included within the spirit and scope of the appended claims which shall to be accorded with the broadest interpretation so as to encompass all such modifications and similar structures.

What is claimed is:

1. A hierarchical PCI system for broadcasting video data from at least a data storage bank to users via a network, comprising:
a logic processor;
a plurality of PCI banks each including at least a network interface port;
at least a SCSI bank; and
a PCI bridge bank including a plurality of PCI bridges;
wherein each said PCI bank connects said logic processor via at least one of said PCI bridges, also connects said SCSI bank via at least one of said PCI bridges, said logic processor is used to receive video demand signals from users, and to send, upon verifying the validity of the video demand signals, a service command block to said SCSI bank, thereby SCSI bank retrieves, according to the service command block and from said data storage bank, the video data demanded by the users, and sends the demanded video data to a corresponding PCI bank to be transmitted to the users via the network interface port thereof and the network, said corresponding PCI bank is selected from among said plurality of PCI banks according to said service command block.

2. The hierarchical PCI system according to claim 1 wherein each said PCI bank further includes a memory and at least a network communication controller connecting said network interface port, said memory for storing the video data received from said SCSI bank and storing an operating program, thereby said network communication controller transmits the video data from said memory to the user via said network interface port connecting therewith and the network.

3. The hierarchical PCI system according to claim 1 wherein each said PCI bank further includes a plurality of network communication controllers, a PCI bank bus, and at least a memory, said memory and each said network communication controller connect said PCI bank bus respectively via one of said PCI bridges.

4. The hierarchical PCI system according to claim 1 further comprising a backbone bus, wherein each said PCI bank and each said SCSI bank connect said backbone bus respectively via one of said PCI bridges, and said backbone bus connects said logic processor via one of said PCI bridges.

5. The hierarchical PCI system according to claim 1 wherein each said PCI bank includes at least a network communication controller driving at least one said network interface port; and said SCSI bank includes at least a SCSI controller and a data storage bank connecting said SCSI controller, thereby said SCSI controller retrieves from said data storage bank the video data demanded by the user, and sends the demanded video data to said memory of said corresponding PCI bank in which said network communication controller transmits the demanded video data from said memory to the user via said network interface port and the network.

6. The hierarchical PCI system according to claim 5 wherein each said PCI bank includes a plurality of slots for plugging at least one said network communication controller in; and said SCSI bank includes a plurality of slots for plugging at least one said SCSI controller.

7. The hierarchical PCI system according to claim 1 wherein each said PCI bank includes at least a network communication controller, said logic processor includes a firmware and at least an interrupt service routine block, said firmware for driving said network interface port and executing said interrupt service routine block, said logic processor also includes a memory for storing user information and content location information.

8. The hierarchical PCI system according to claim 7 wherein said user information includes user identification, user on-line record, user passwords; and said logic processor issues said SCSI service command block according to said user information, said content location information, and the video demand signals received from the user; and said logic processor sends said SCSI service command block to said SCSI bank.

9. The hierarchical PCI system according to claim 7 wherein said interrupt service routine block includes an interrupt service routine for controlling data transfer bit rate, another interrupt service routine for processing said SCSI service command block, and the other three interrupt service routines for managing failure of said SCSI bank.

10. The hierarchical PCI system according to claim 1 wherein each said PCI bank includes at least a network communication controller, and said SCSI service command block includes content location of the video data demanded by the user, content bit rate, data start address, location of the network interface port via which the video data is to be transmitted to the user, and actual data length to play.

11. The hierarchical PCI system according to claim 10 further comprising a server management unit for storing information about the video data and for providing said logic processor with the stored information about the video data, thereby said logic processor issues said SCSI service command block according to the stored information about the video data, and the video demand signals received from the user.

12. A process working with a hierarchical PCI system for broadcasting video data from at least a data storage bank to users via a network, comprising the steps of:
(1) receiving a video demand signal from the user via a network interface port of said hierarchical PCI system;
(2) locating a corresponding SCSI controller which is a SCSI controller of said hierarchical PCI system and which corresponds to said video demand signal;
(3) providing a SCSI service command block to drive said corresponding SCSI controller for retrieving, from a data storage bank connected therewith, the video data demanded by the user, and sending the retrieved video data to a memory of a PCI bank of said PCI system; and
(4) transmitting the retrieved video data from said memory to the user via said network and a network interface port of said PCI bank.

13. The process according to claim 12 wherein step (2) includes a step of sending said video demand signal to a server management unit of said hierarchical PCI system, for said server management unit to find the location of said corresponding SCSI controller.

14. The process according to claim 13 wherein said server management unit further finds video-data-related information including content bit rate and data start address of the video data, location of network interface port via which the video data is to be transmitted to the user, and the actual data length of the video data to play, thereby said SCSI controller retrieves, according to said video-data-related information and from a data storage bank, the video data demanded by the user, and sends the retrieved video data to said memory of said PCI bank, whereby the network communication controller of said PCI bank transmits, according to said video-data-related information, the video data demanded by the user from said memory to the user via a network interface port of said PCI bank and the network.

15. The process according to claim 12 further comprising, before step (3), a step of executing a first interrupt service routine to provide a first routine output, thereby said SCSI service command block is provided to said SCSI controller in response to said first routine output.

16. The process according to claim 12 further comprising, before step (5), a step of executing a second interrupt service routine to provide a second routine output, thereby the video data demanded by the user is transmitted, with a data length and content bit rate corresponding to said second routine output, to the user via a network interface port of said PCI bank and the network.

17. A hierarchical PCI system working with a logic processor for broadcasting video data from at least a data storage bank to users via a network, comprising:
a plurality of PCI banks each including at least a network interface port;
at least a SCSI bank; and
a PCI bridge bank including a plurality of PCI bridges.
wherein each said PCI bank connects said logic processor via at least one of said PCI bridges, also connects said SCSI bank via at least one of said PCI bridges, said logic processor is used to receive video demand signals from users, and to send, upon verifying the validity of the video demand signals, a service command block to said SCSI bank, thereby SCSI bank retrieves, according to said service command block and from said data storage bank, the video data demanded by the users, and sends the demanded video data to a corresponding PCI bank to be transmitted to the users via the network interface port of said corresponding PCI bank and the network, said corresponding PCI bank is selected from among said plurality of PCI banks according to said service command block.

18. The hierarchical PCI system according to claim 17 wherein said corresponding PCI bank further comprises at least a network communication controller and a memory, said memory for storing the video data received from said SCSI bank and storing an operating program of said corresponding PCI bank, thereby said network communication controller in said corresponding PCI bank transmits the video data, according to a predetermined content bit rate, from said memory to the user via the network, and one said network interface port of said corresponding PCI bank.

19. The hierarchical PCI system according to claim 17 wherein each said PCI bank includes a plurality of network communication controllers, a PCI bank bus, and at least a memory, said memory and each said network communication controller connect said PCI bank bus respectively via one of said PCI bridges.

20. The hierarchical PCI system according to claim 17 further comprising a backbone bus, wherein each said PCI bank and said SCSI bank connect said backbone bus respectively via one of said PCI bridges, said backbone bus connects said logic processor via one of said PCI bridges, each said PCI bank includes a memory and at least a network communication controller, each said network communication controller drives at least a network interface port, said SCSI bank connects at least a data storage bank, thereby said SCSI bank retrieves from said data storage bank the video data demanded by the user, and sends the demanded video data to said memory of a corresponding PCI bank, thereby the network communication controller of said corresponding PCI bank transmits the demanded video data to the user via a network interface port of said corresponding PCI bank and the network.
